(19) United States
(12) Patent Application Publication
(10) Pub. No.: US 2025/0191866 A1
(43) Pub. Date: Jun. 12, 2025

(54) SWITCHING DEVICE AND METHOD FOR OPERATING A SWITCHING DEVICE

(71) Applicant: Eaton Intelligent Power Limited, Dublin 4 (IE)

(72) Inventors: Kai SCHROEDER, Niederkassel, NRW (DE); Lutz FRIEDRICHSEN, Langerwehe, NRW (DE); Gabriel WIEDERA, Bonn, NRW (DE)

(21) Appl. No.: 18/686,296

(22) PCT Filed: Oct. 5, 2022
(86) PCT No.: PCT/EP2022/025462

§ 371 Date: Feb. 23, 2024

(30) Foreign Application Priority Data
Oct. 7, 2021 (GB) 2114360.7

(51) Int. Cl. H01H 73/04

(52) U.S. Cl. CPC H01H 73/045

(57) ABSTRACT

A switching device comprises a first and a second fixed contact, a contact bridge, a first and a second movable contact arranged at the contact bridge, at least one contact spring and a contact bridge carrier which is movable, is coupled to the contact bridge via the at least one contact spring and comprises a carrier tip. The switching device further comprises a lever arm connected to the contact bridge and comprises a tip configured to irreversibly engage with the carrier tip of the contact bridge carrier in case of a short circuit.

The present disclosure is related to a switching device and a method for operating a switching device.

The switching device is realized as electromechanical switching device, e.g. for conducting and switching bidirectional DC currents, especially for a high-power battery network in the field of electro-mobility. Within short-circuit switching of the switching device, strong dynamic forces react on the contact system due to the high currents. The resulting strong opening impulse can lead to rebound and recontacting of the contact system in the switching device. Reclosing of the contacts may e.g. result in different issues: Due to the reclosing, the switching device does not achieve galvanic isolation. Reclosing of the contacts can lead to recurring bouncing, since the short-circuit current can flow again when the contacts are closed, this leads to repeating the initial issue. Due to the reclosing an extinguishing time and a stress in the switching device increases.

Document WO 2020/035489 A1 describes a switching device for carrying and disconnecting bidirectional DC currents, suitable for high-voltage networks in electric vehicles.

Document DE 10 2017 111583 A1 describes a disconnector with a rotor arrangement. The disconnector has an electrically insulated housing. The rotor arrangement is arranged within the electrically insulated housing. The rotor arrangement includes a contact arm and a rotor that is rotatable relative to the electrically insulated housing. The contact arm is connected to the rotor and is movable between a first position in which a conductive path is closed, and a second position in which the conductive path is open. The rotor arrangement also includes a locking mechanism that is coupled to the rotor. The locking mechanism holds the contact arm in the second position during a short circuit event. The locking mechanism is spaced from the contact arm when the contact arm is in the first position. The locking mechanism engages the contact arm when the contact arm is in the second position. The disconnector comprises an actuating mechanism coupled to the rotor assembly. The locking mechanism releases the contact arm, when the actuating mechanism is actuated.

Document DE 10 2008 024387 A1 is related to a switching device. The switching device includes a stationary contact element and a movable contact element. The movable contact element automatically switches under an electromagnetic force in the event of a short circuit. The movable contact element should not move back towards the stationary contact element after an impact of the movable contact element on a component, e.g. a housing part of the switching device. Means are provided for braking the speed of the movable contact element. For example, a pin can cooperate with a damper element so that braking is achieved by frictional force.

Document EP 0 619 593 A1 describes a multipole current limiting circuit breaker with electrodynamic repulsion. The current-limiting circuit breaker comprises a current interrupting device having per pole separable contact elements by electrodynamic repulsion. The circuit breaker includes an operating mechanism with a connecting spring, a release device and a knee joint and a switching bar made of insulating material acting as support for the movable contacts of all poles. The bar is mechanically coupled to the knee joint to be moved by the operating mechanism between the closed position and the open position of the contacts. The circuit breaker comprises a handle coupled to the operating mechanism and passing through an aperture in a front panel of a case. The movable contact can be moved by electrodynamic repulsion from a first rest position to a second active position. Furthermore, the circuit breaker includes flexible means comprising a spring housed in a recess of the bar to provide the contact pressure and to slow down the drop-back of the movable contact to the first rest position. The spring cooperates with sliding with a bearing surface of the movable contact.

Document DE 10 2008 047247 A1 refers to a contact system for a switching device with a contact member rotatably mounted on a switching shaft segment and with a locking device arranged axially between them. The contact system has a contact member with at least one contact arm rotatably mounted in a switching shaft segment. The switching shaft segment is designed for turning the contact member into an on position or an off position rotatable about an axis of rotation. The contact member has at least a contact arm each with a movable contact. The contact system also has at least one latching device for fixing or releasing the contact member in dependence on contact-removing forces which act on the contact member. To unlock the contact member from this fixed locking rotation position, the switching shaft segment is manually turned into the on position.

It is an object to provide a switching device and a method for operating a switching device that reduces the probability for a recontacting of the switching contacts.

These objects are achieved by the subject-matter of the independent claims. Further developments and embodiments are described in the dependent claims.

There is provided a switching device comprising a first and a second fixed contact, a contact bridge, a first and a second movable contact arranged at the contact bridge, at least one contact spring and a contact bridge carrier which is movable, is coupled to the contact bridge via the at least one contact spring and comprises a carrier tip. The switching device further comprises a lever arm connected to the contact bridge and comprising a tip. The tip of the contact bridge is configured to irreversibly engage with the carrier tip of the contact bridge carrier in case of a short circuit.

Advantageously, the tip of the lever arm and the carrier tip obtain the function of a latch in case of a short circuit. The movement of the contact bridge relative to the contact bridge carrier can be stopped. The kinetic energy of the contact bridge is reduced. The probability of re-connecting is highly reduced during or after forced contact bridge opening induced by high energy short circuit arcs.

In an embodiment of the switching device, the tip of the lever arm and the carrier tip of the contact bridge carrier are configured to provide a latching between the lever and the contact bridge carrier in case of a short circuit.

In an embodiment of the switching device, the lever arm and the contact bridge carrier are configured to hold the contact bridge in an off position or switched-off state after a short circuit.

In an embodiment, the switching device is free of a mechanism to set the contact bridge in an on-position or switched-on state after the short circuit.

In an embodiment, the switching device is implemented as a one-time switch. The switching device cannot be used again after a short circuit.

In an embodiment of the switching device, the first and the second movable contact are made of a metal. The first and the second movable contact have a thickness in a range between 0.5 mm and 1.5 mm or alternatively in a range between 0.75 mm and 1.25 mm.

In an embodiment of the switching device, the first and the second fixed contact are made of a metal. The first and the second fixed contact have a thickness in a range between 0.5mm and 1.5 mm or alternatively in a range between 0.75 mm and 1.25 mm.

In an embodiment, the switching device comprises a first terminal contact at which the first fixed contact is attached and a second terminal contact at which the second fixed contact is attached.

In an embodiment, the switching device is configured that a current flowing in case of a short circuit through the first fixed contact, the first movable contact, the contact bridge, the second movable contact and the second fixed contact causes the movement of the contact bridge relative to the contact bridge carrier in case of a short circuit.

In an embodiment, the switching device comprises an armature. The armature is movable and is directly connected to the contact bridge carrier. The switching device is configured that the movement of the contact bridge relative to the contact bridge carrier in case of a short circuit starts before the armature starts to move.

In an embodiment of the switching device, the lever arm is configured to be bended towards the carrier tip by the movement of the contact bridge in case of a short circuit. For example, the contact bridge carrier is opposite of the lever arm, e.g. opposite of the tip of the lever arm.

In an embodiment of the switching device, the contact bridge is configured to perform a rotational movement in case of a short circuit and to perform a linear movement at a transition from a switched-off state to a switched-on state of the switching device, and at a transition from a switched-on state to a switched-off state of the switching device.

In an embodiment of the switching device, the contact bridge is configured in a C-form, U-form, C-shape or U-shape. The contact bridge includes a first leg end, a second leg end and an intermediate section. The first movable contact is attached to the first leg end. The second movable contact is attached to the second leg end. The intermediate section connects the first leg end to the second leg end and is connected to the lever arm. The lever arm is connected at least to the intermediate section.

There is provided a method of operating of a switching device. The switching device comprises a first and a second fixed contact, a contact bridge, a first and a second movable contact arranged at the contact bridge, at least one contact spring, a contact bridge carrier and a lever arm. The contact bridge carrier is movable, comprises a carrier tip and is coupled to the contact bridge via the at least one contact spring. The lever arm is connected to the contact bridge and comprising a tip. The method comprises irreversibly engaging of the tip with the carrier tip in case of a short circuit.

Advantageously, the switching device realizes a mechanical system to minimize contact rebound in a short circuit switching device. The DC switching device obtains an improved short circuit switching behavior due to a mechanical latch. The latch is realized by the tip of the lever arm and the carrier tip of the contact bridge carrier.

The method for operating a switching device may be implemented e.g. by the switching device according to one of the embodiments defined above.

In an example, the switching device is implemented as an electromechanical switching device for conducting and switching bidirectional DC currents, especially for high-power battery networks in the field of electro-mobility.

In an example, the switching device implements a latching device for the contact bridge of a short circuit switching device. The latching device for the contact bridge of a short-circuit switching device uses a latching to prevent the switching device from recontacting. A rebound brake uses the dynamic force of a short circuit event which acts on the contact system. These forces ensure a dynamic movement of the contact system which is passed on to a latching geometry. The latching geometry now engages and ensures that the contact bridge is held in the off position. This means that the contacts cannot recontact after a short circuit.

The switching device may be part of an electric vehicle and/or hybrid vehicle. The switching device may be realized as a contactor or circuit breaker. The switching device may be realized as switching in air or as a gas-tight sealed switching device.

The following description of figures of embodiments may further illustrate and explain aspects of the switching device. Parts and devices with the same structure and the same effect, respectively, appear with equivalent reference symbols. In so far as parts or devices correspond to one another in terms of their function in different figures, the description thereof is not repeated for each of the following figures.

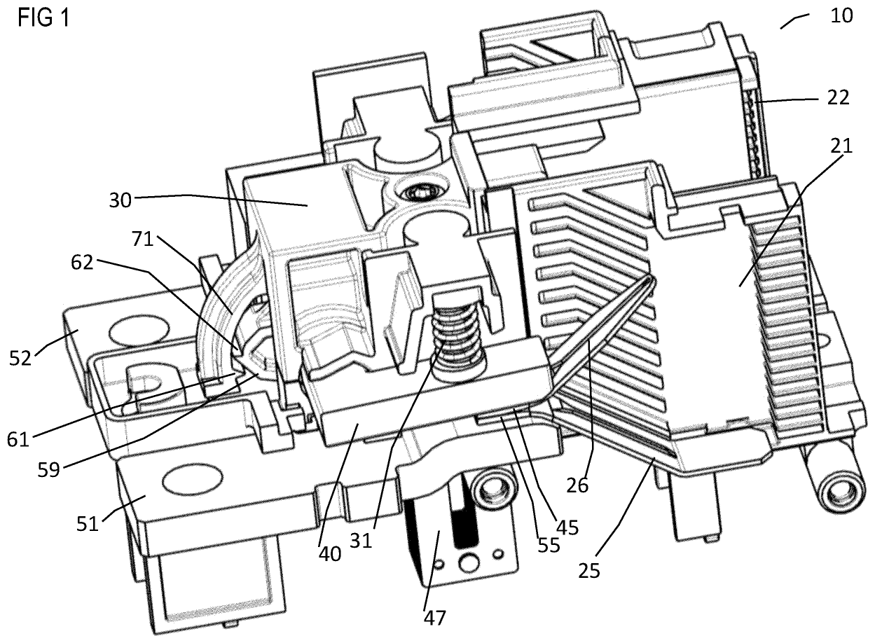

FIGS. 1 to 7 show an example of a switching device in different states.

FIG. 1 shows an example of a switching device 10. The switching device 10 comprises a first movable contact 45, a second movable contact, a first fixed contact 55, a second fixed contact and a contact bridge 40. The contact bridge 40 is realized as a cuboid bended in a C-form or U-form. The contact bridge 40 may be made of copper. The contact bridge 40 may be called switching bridge or switching contact bridge. The first and the second movable contact 45 are fixed on the contact bridge 40. The switching device 10 includes a first terminal contact 51 and a second terminal contact 52. The first fixed contact 55 is fixed on the first terminal contact 51. The second fixed contact is fixed on the second terminal contact 52. The first and the second terminal contact 51, 52 are made e.g. of copper.

The contact bridge 140 has a C-form or a U-form. The first and the second movable contact 45 are located at a first and a second leg end of the contact bridge 40. An intermediate section of the contact bridge 40 connects the first leg end to the second leg end.

The switching device 10 comprises a contact bridge carrier 30. The contact bridge carrier 30 is e.g. made of plastics. The contact bridge carrier 30 is e.g. made of a polymer, such as e.g. thermoplastic or thermoset material. The material of the contact bridge carrier 30 has e.g. high dimensional and temperature stability as well as electrical resistance against currents at its surface. The contact bridge 40 is inserted into the contact bridge carrier 30.

The switching device 10 comprises a contact spring 31 that can be named contact pressure spring. The contact spring 31 couples the contact bridge 40 to the contact bridge carrier 30. The switching device 10 comprises a further contact spring (not shown) that also couples the contact bridge 40 to the contact bridge carrier 30. The two contact springs 31 are arranged above the two movable contacts 45. The contact bridge carrier 30 is movable. The switching device 10 comprises a lever arm 59 connected to the contact bridge 40. The lever arm 59 comprises a tip 62. The contact bridge carrier 30 comprises a carrier tip 61 directed towards the lever arm 59. The carrier tip 61 is e.g. made of a polymer, such as e.g. thermoplastic or thermoset material. The carrier tip 61 and at least a part of the contact bridge carrier 30 are e.g. out of the same material.

Moreover, the switching device 10 comprises a magnetic drive assembly with an armature 47. The magnetic drive assembly comprises an electric coil (not shown) and a magnet core (not shown) which holds the electric coil. The armature 47 is fastened to the contact bridge carrier 30. The armature 47 is coupled via the contact bridge carrier 30 and the contact spring 31 to the contact bridge 40. The contact spring 31 may be made of steel such as inox steel. The contact spring 31 and the further contact spring press the contact bridge 40 in the direction of the first and second terminal contact 51, 52. The contact spring 31 and the further contact spring fix the contact bridge 40 in its target position. The contact spring 31 and the further contact spring ensures the appropriate contact force when the switching device 10 is in the switched-on state.

Furthermore, the switching device 10 comprises a first arc runner 25 connected to the first terminal contact 51. Moreover, the switching device 10 comprises a second arc runner 26 connected to the contact bridge 40 in vicinity of the first movable contact 45. Additionally, the switching device 10 comprises a third arc runner (not shown) connected to the second terminal contact 52. Moreover, the switching device 10 comprises a fourth arc runner (not shown) connected to the contact bridge 40 in vicinity of the second movable contact.

A first arcing chamber 21 of the switching device 10 is connected to the first arc runner 25. A second arcing chamber 22 of the switching device 10 is connected to the third arc runner. The first and the second arcing chamber 21, 22 comprise a number of splitter plates (not shown). Moreover, the switching device 10 e.g. comprises a permanent magnet system (not shown) having a permanent magnet and a first and a second pole plate. The contact bridge 40, the first and the second terminal contact 51, 52 and the first and the second arcing chamber 21, 22 are arranged between the first and the second pole plates.

The switching device 10 is configured to be set in a switched-on state, a switched-off state or a locked state.

In FIGS. 1 to 7, the operation of the switching device 10 is shown.

In FIG. 1, the switching device 10 is in the switched-on state. Here, the two movable contacts 45 are in contact to the two fixed contacts 55, e.g. with a contact force required for the permanent conduction of the rated current. The contact springs 31 are slightly compressed compared to the switched-off state to apply the contact force required for a permanent current flow. In this case, the position of the contact bridge 40 is slightly rotated with respect to the position of the two terminal contacts 51, 52. Accordingly, the tip 62 does not contact the contact bridge carrier 30.

The switching device 10 is set from the switched-off state into the switched-on state by a movement of the contact bridge 40 in a direction perpendicular to the contact bridge 40. The contact bridge 40 has a first and a second main surface. The movable contacts 45 are located at the first main surface of the contact bridge 40. The movement is perpendicular to the first main surface of the contact bridge 40. The armature 47 moves the contact bridge 40 via the contact bridge carrier 30 and the at least one contact spring 31 towards the first and the second terminal contact 51, 52. Thus, a load current can flow from the first terminal contact 51 via the first fixed contact 55, the first movable contact 45, the contact bridge 40, the second movable contact and the second fixed contact to the second terminal contact 52.

The tip 62 is not in contact with the carrier tip 61 in the switched-on state.

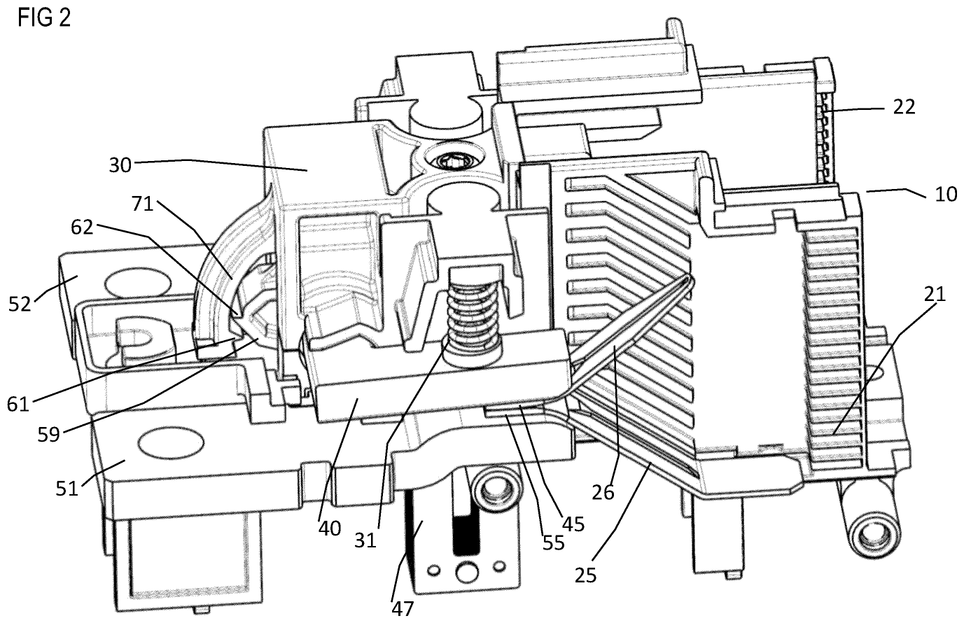

FIG. 2 shows the example of the switching device 10 shown in FIG. 1 in the switched-on state in another perspective.

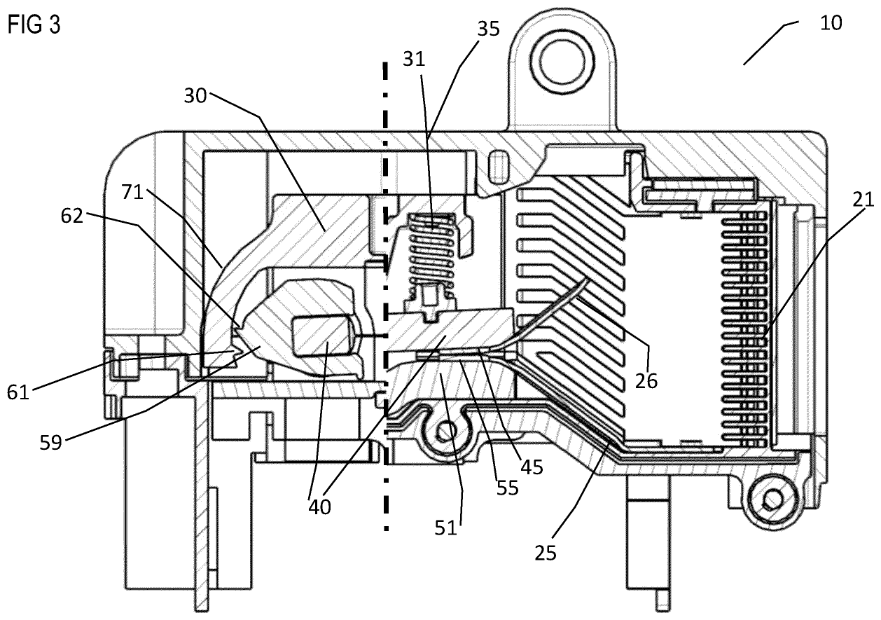

FIG. 3 shows the example of the switching device 10 shown in FIGS. 1 and 2 in the switched-on state in cross sections. The cross-sections are shown in different planes: On the left side of the dashed line, the cross-section shows the lever arm 59, whereas on the right side of the dashed line, the cross-section shows one of the two leg ends of the contact bridge 40 with the movable contact 45. Thus, the plane on the left side of the dashed line is “deeper” than the plane on the right side of the dashed line. The switching device 10 includes a housing 35.

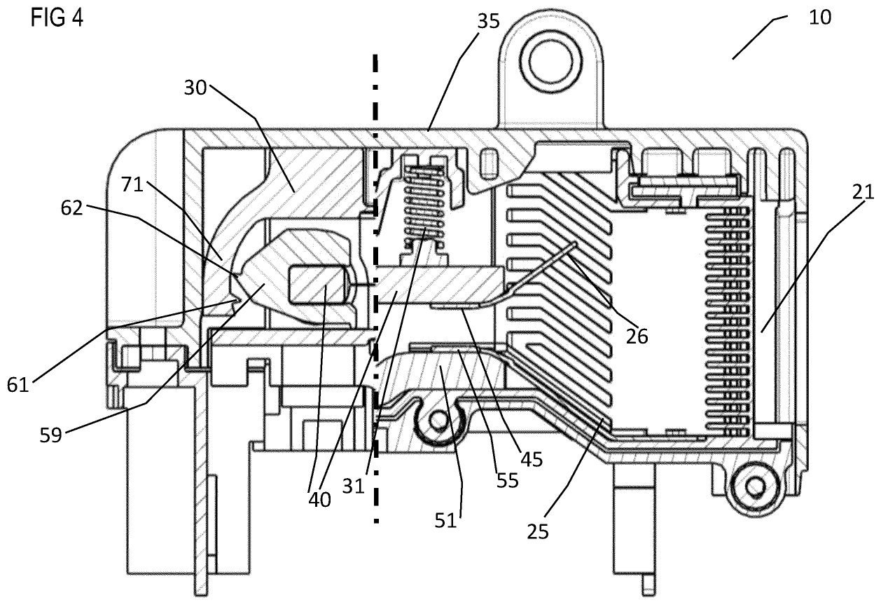

FIG. 4 shows the example of the switching device 10 shown in FIGS. 1 to 3 in the switched-off state in cross sections. In the switched-off state, the first and the second fixed contact 55 are not in contact with the first and the second movable contact 45. Thus, a flow of a load current from the first terminal contact 51 to the second terminal contact 52 via the contact bridge 40 is inhibited. The switching device 10 is set from the switched-on state into the switched-off state by a movement of the contact bridge 40 that separates the contact bridge 40 from the first and the second terminal contact 51, 52. In case of a load current flowing before switching, a first arc may be generated between the first fixed contact 55 and the first movable contact 45 and a second arc may be generated between the second movable contact and the second fixed contact.

At the transition between the switched-on state to the switched-off state, the armature 47 moves the contact bridge carrier 30 and the contact bridge 40 away from the first and the second terminal contact 51, 52. In case of a regular disconnection operation, the contact bridge 140 moves in a purely translatory manner in the direction of the movement of the armature 47. In FIG. 4 the situation in the regularly disengaged state is shown. The contact bridge 40 is exactly parallel to the two terminal contacts 51, 52. The tip 62 of the lever arm 59 also touches an area of the arch almost without friction.

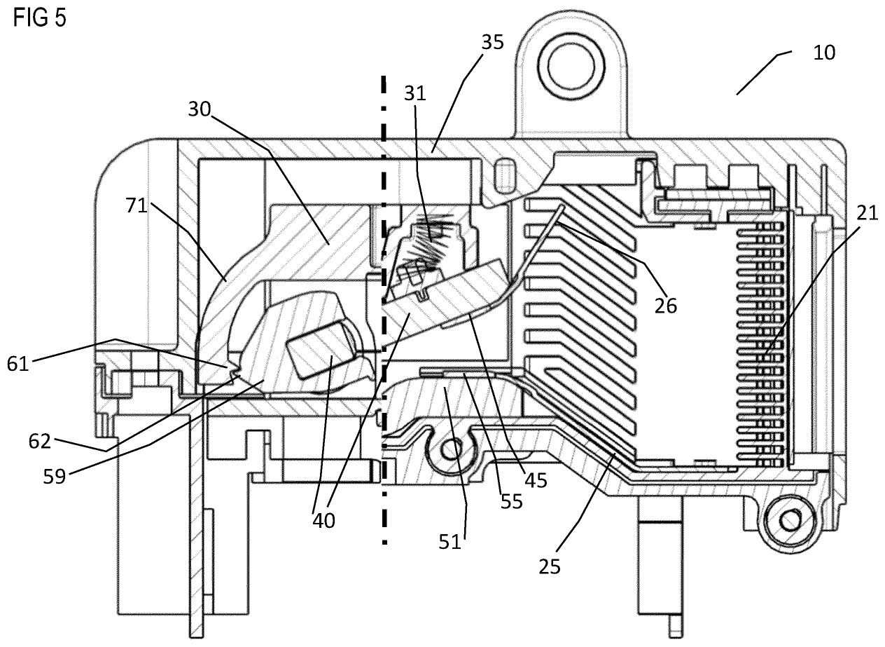

FIG. 5 shows the example of the switching device 10 shown in FIGS. 1 to 4 in case of a short circuit. The words “in case of a short circuit” can be replaced e.g. by the words “in the event of a short circuit”.

In this state, the pole faces of the magnetic core and the armature 20 are separated from each other, the fixed contacts 55 are not in contact with the movable contacts 45 and the contact spring 31 is compressed.

In the short circuit case with a high short circuit current, a dynamic tearing open of the switching contacts occurs. The contact bridge 40 moves upwards. The tip 62 of the lever arm 59 moves across the carrier tip 61. A first side of the tip 62 and a first side of the carrier tip 61 have a slope that allows a gliding of the tip 62 across the carrier tip 61 in case of a short circuit. A second side of the tip 62 and a second side of the carrier tip 61 have a slope that do not allow a gliding of the tip 62 across the carrier tip 61 in case the short circuit has ended. The slope of the second side of the carrier tip 61 may be approximately perpendicular to the contact bridge carrier 30.

The latching movement associated with this removes kinetic energy from the dynamic contact opening process and thus mitigates the rebound effect of the contact bridge 40 at an early stage so that the movable contacts 45 are not re-contacted to the fixed contacts 55.

In case of a short circuit with a high short circuit current, the eccentric arrangement of the movable contacts 45 causes a rotational dynamic contact opening (FIG. 5). This rotational movement of the contact bridge 40 is correspondingly transmitted to the eccentric lever arm 59, which is directly connected to the contact bridge 40 and is arranged on the other side of the rotational axis of the contact bridge 40 with respect to the movable contacts 45.

The lever arm 59 functions as a brake finger. The lever arm 59 is fixed to the contact bridge 40. The lever arm 59 is attached to the intermediate section of the contact bridge 40. During its rotational movement during the dynamic opening process, the tip 62 of the lever arm 59 performs a contacting movement along a contacting area of the contact bridge carrier 30. The contact bridge carrier 30 includes an arch that is e.g. realized as plastic arch or plastic sheet which is integrally connected to the contact bridge carrier 30 and is e.g. preferentially made of the same thermoplastic or thermoset material as the contact bridge carrier 30.

The lever arm 59 comprises e.g. a thermoplastic or thermoset material. However, the lever arm 59 may also comprise a suitable other material, for example a metallic material. The tip 62 is part of the lever arm 59. Alternatively, the tip 62 is inserted into the lever arm 59. The tip 62 and at least a part of the lever arm 59 are e.g. made out of the same material. The tip 62 is e.g. a plastic tip or a metallic tip. The contour of the arch is such that, during the rotational movement of the contact bridge 40 in case of a short circuit, there is e.g. permanent contact between the tip 62 of the lever arm 59 and the arch. This contacting can be implemented in such a way that the arch has an approximately circular contour in a contacting area which follows the rotational movement of the tip 62. With only a small angle of rotation, only a small frictional force is generated by the contact of the tip 62 with the arch. As the angle of rotation increases, the transmitted frictional force also increases. This can advantageously be done in such a way that as the angle of rotation increases, the radius of curvature of the surface contour becomes smaller than the radius of the circular motion described by the tip 62 of the lever arm 59.

In another embodiment, instead of having a radius of curvature that is dependent on the angle of rotation, the contacting area can also have a surface structure that changes with the angle of rotation, such as corrugation or serrations in a contacting area in the region of larger angles of rotation. The contacting area is e.g. a rough or toothed area.

As a result, the rotary movement of the contact bridge 40 induced by the dynamic current forces in case of a short circuit causes a frictional force which increases with increasing angle of rotation and which reduces the dynamic movement of the rotated contact bridge 40.

Moreover, the latching of the tip 62 with the carrier tip 61 stops any movement of the contact bridge towards the switched-on state of the switching device 10. Thus, no re-contacting of the switching contacts occurs in the course of the immediately following (linear) opening movement of the armature 47 with the relaxation of the two contact springs 31.

In FIG. 5, the situation in case of a short circuit is shown. In case of a high short circuit current, the movable contacts 45 are torn open by the dynamic current forces, combined with a rotation of the contact bridge 40. As a result of the rotational movement, the contact springs 31 are compressed to a greater extent than in the regular switch-on case, as well as being slightly displaced in the transverse direction, and at the same time the tip 62 of the lever arm 59 penetrates more or less deeply into the contacting area of the plastic arch, until the tip 62 crosses the carrier tip 61, depending on the level of the short circuit current. The frictional energy expended for this purpose causes the braking of the movement of the contact bridge 140 required to prevent undesired re-contacting and the latching stops any movement into the switched-on state.

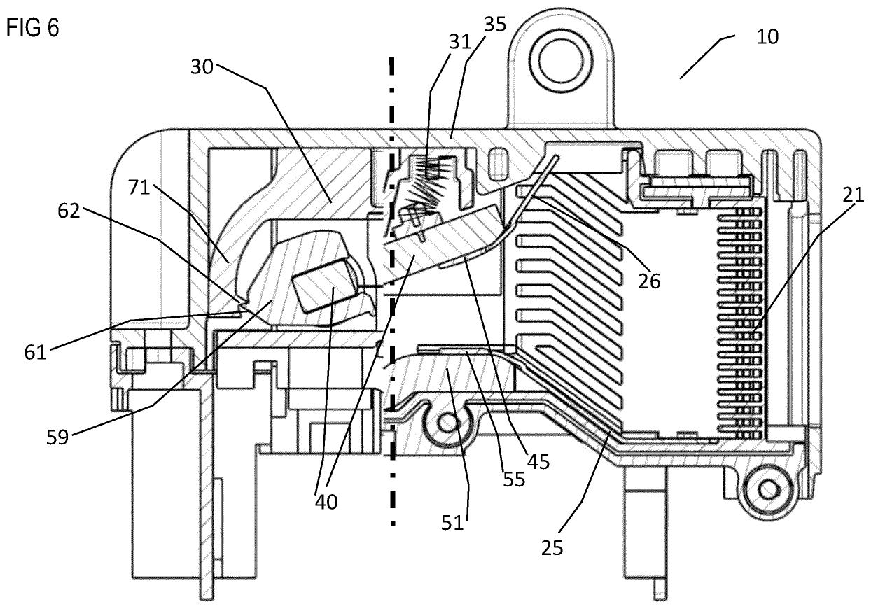

FIG. 6 shows the example of the switching device 10 shown in FIGS. 1 to 5 in case of a short circuit. In a second state of a short circuit, the armature 47 moves the contact bridge carrier 30 in the position of the switched-off state of the switching device 10. The first state of a short circuit is shown in FIG. 5. The movement of the contact bridge 40 is faster than the movement of the armature 47 in case of a short circuit.

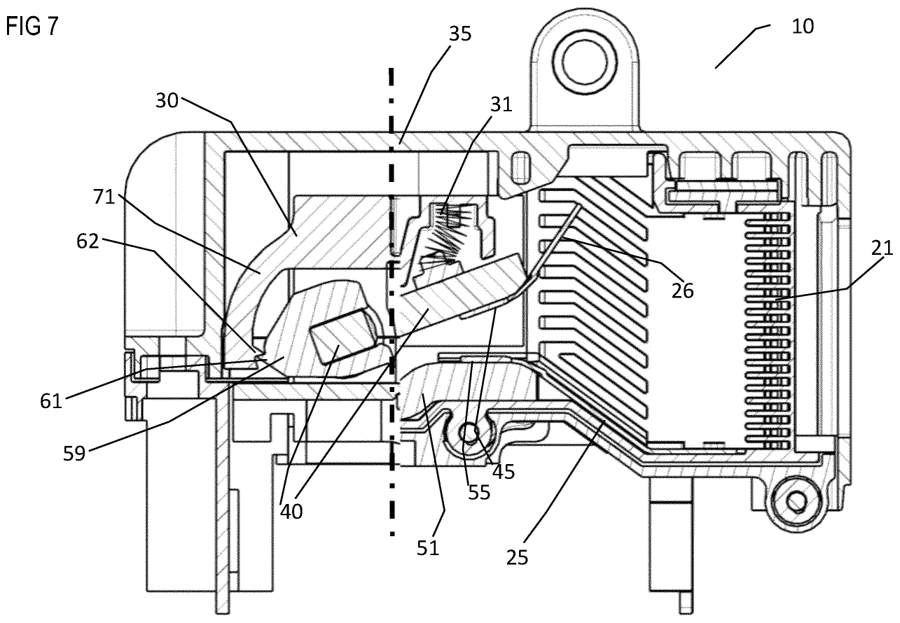

FIG. 7 shows the example of the switching device 10 shown in FIGS. 1 to 6 after a short circuit. In case the switching device 10 receives a control signal to move into the switched-on state, the armature 47 moves the contact bridge carrier 30 and thus indirectly also the contact bridge 40. Due to the latching of the two tips 61, 62, the contact bridge 40 cannot be moved in a position that allows a contact of the movable contacts 45 to the fixed contacts 55.

Thus, the carrier tip 61 of the contact bridge carrier 30 and the tip 62 of the contact bridge 40 are irreversibly engaged in case of a short circuit or after a short circuit. Irreversibly means that the tip 62 of the contact bridge 40 is continuously held in a fixed position by the carrier tip 61 of the contact bridge carrier 30 after a short circuit. The switching device 10 is configured such that the fixed position cannot be released after a short circuit. In an example, the fixed position cannot be released after a short circuit by an electrical signal provided to the switching device 10 or by manual resetting the switching device 10. For example, after a short circuit, the cause for the short circuit has to be found and removed and the switching device 10 has to be replaced by another switching device, before an arrangement that includes the switching device 10 can start operation again. Advantageously, a safety of the arrangement is increased by the irreversibility of the state of the switching device 10 after a short circuit.

In an example, the switching device 10 is designed to be set in the switched-off state as shown in FIG. 4 by a manual repair, e.g. after removing the switching device 10 from an arrangement that includes the switching device 10.

In an alternative, not shown embodiment, this fixed position can only be released by manual resetting the switching device 10 (using e.g. a button, pushbutton or lever). Irreversibly means that after a short circuit the tip 62 of the contact bridge 40 is continuously held in the fixed position by the carrier tip 61 of the contact bridge carrier 30 up to a point of time at which a person manually releases the switching device 10. The switching device 10 is designed that e.g. no electrical signal is able to release the switching device 10.

The embodiments shown in FIGS. 1 to 7 as stated represent examples of the improved switching device 10 and method; therefore, they do not constitute a complete list of all embodiments according to the improved switching device and method. Actual switching device and methods may vary from the embodiments shown in terms of parts, structures and shape, for example.

### REFERENCE NUMERALS

10 switching device
21 first arcing chamber
22 second arcing chamber
25, 26 arc runner
30 contact bridge carrier
31 contact spring
35 housing
40 contact bridge
45 first movable contact
47 armature
51 first terminal contact 51
52 second terminal contact
55 first fixed contact
59 lever arm
61 carrier tip
62 tip

1-13. (canceled)

14. A switching device, comprising
a first and a second fixed contact,
a contact bridge,
a first and a second movable contact arranged at the contact bridge,
at least one contact spring,
a contact bridge carrier which is movable, is coupled to the contact bridge via the at least one contact spring and comprises a carrier tip,
a lever arm connected to the contact bridge and comprising a tip,
wherein
that the tip of the lever arm is configured to irreversibly engage with the carrier tip of the contact bridge carrier in case of a short circuit,
wherein the tip of the lever arm is continuously held in a fixed position by the carrier tip of the contact bridge carrier after a short circuit, and
wherein the switching device is configured such that the fixed position cannot be released after a short circuit.

15. The switching device according to claim 14,
wherein the tip of the lever arm and the carrier tip of the contact bridge carrier are configured to provide a latching between the lever arm and the contact bridge carrier in case of a short circuit.

16. The switching device according to claim 14,
wherein the lever arm and the contact bridge carrier are configured to held the contact bridge in a switched-off state after a short circuit.

17. The switching device according to claim 14,
wherein the switching device is free of a mechanism to set the contact bridge in a switched-on state after the short circuit.

18. The switching device according to claim 14,
wherein the first and the second movable contact are made of a metal and have a thickness in a range between 0.5 mm and 1.5 mm.

19. The switching device according to claim 14,
wherein the first and the second fixed contact are made of a metal and have a thickness in a range between 0.5 mm and 1.5 mm.

20. The switching device according to claim 14,
wherein the switching device comprises
a first terminal contact at which the first fixed contact is attached and
a second terminal contact at which the second fixed contact is attached.

21. The switching device according to claim 14,
wherein the switching device is configured that a current flowing in case of a short circuit through the first fixed contact, the first movable contact, the contact bridge, the second movable contact and the second fixed contact causes a movement of the contact bridge relative to the contact bridge carrier in case of a short circuit.

22. The switching device according to claim 14,
wherein the switching device comprises an armature,
wherein the armature is movable and is coupled to the contact bridge carrier, and
wherein the switching device is configured that the movement of the contact bridge relative to the contact bridge carrier in case of a short circuit starts before the armature starts to move.

23. The switching device according to claim 14,
wherein the lever arm is configured to be bended towards the carrier tip by the movement of the contact bridge in case of a short circuit.

24. The switching device according to claim 14,
wherein the contact bridge is configured to perform a rotational movement in case of a short circuit and to perform a linear movement
at a transition from a switched-off state to a switched-on state of the switching device, and
at a transition from a switched-on state to a switched-off state of the switching device.

25. The switching device according to claim 14,
wherein the contact bridge is configured in a C-form or U-form and includes a first leg end, a second leg end and an intermediate section,
wherein the first movable contact is attached to the first leg end,
wherein the second movable contact is attached to the second leg end, and
wherein the intermediate section connects the first leg end to the second leg end and is connected to the lever arm.

26. A method for operating a switching device,
wherein the switching device comprises a first and a second fixed contact, a contact bridge, a first and a second movable contact arranged at the contact bridge, at least one contact spring, a contact bridge carrier which is movable, comprises a carrier tip and is coupled to the contact bridge via the at least one contact spring and a lever arm connected to the contact bridge and comprising a tip,
wherein
that the method comprises:
irreversibly engaging of the tip with the carrier tip in case of a short circuit,
wherein the tip of the lever arm is continuously held in a fixed position by the carrier tip of the contact bridge carrier after a short circuit, and
wherein the fixed position cannot be released after a short circuit.
